(19) United States
(12) Patent Application Publication
(10) Pub. No.: US 2024/0381882 A1
(43) Pub. Date: Nov. 21, 2024

(54) INDOOR SMOKER APPLIANCE

(71) Applicant: Haier US Appliance Solutions, Inc., Wilmington, DE (US)

(72) Inventors: Richard Suel, Louisville, KY (US); George Carpenter, Louisville, KY (US); Steven Fox, Daytona Beach, FL (US)

(21) Appl. No.: 18/319,127

(22) Filed: May 17, 2023

(51) Int. Cl. A23B 4/052; B01D 53/86

(52) U.S. Cl. CPC A23B 4/052; B01D 53/864

(57) ABSTRACT

An indoor smoker includes a cabinet; a smoking chamber positioned within the cabinet and defining a chamber inlet and a chamber outlet; a smoke generation system in fluid communication with the smoking chamber; an exhaust duct; an air handler provided within the exhaust duct, the air handler creating a negative pressure within the smoking chamber; a catalytic converter positioned within the exhaust duct upstream from the air handler; and a plurality of seals provided within the cabinet. The plurality of seals includes an inlet seal provided at the chamber inlet between the smoke generation system and the smoking chamber and an outlet seal provided at the chamber outlet between the exhaust duct and the smoking chamber.

### FIELD OF THE INVENTION

The present subject matter relates generally to indoor smokers, and more particularly to systems and methods of smoke and emissions regulation in indoor smokers.

### BACKGROUND OF THE INVENTION

Conventional smokers include a smoking chamber and a firebox positioned within or fluidly coupled to the smoking chamber. The firebox is filled with a combustible material, such as wood or wood byproducts that are ignited or otherwise heated to generate smoke and/or heat. The heat and smoke are routed into the smoking chamber to impart flavor on and cook food items positioned within the smoking chamber. One or more heating elements may be positioned within the smoking chamber and the firebox to maintain the temperatures necessary both for cooking the food and for generating the desired amount of smoke.

Conventional smokers are used outdoors and simply exhaust smoke directly outside through a chimney or vent. Notably, such smoke frequently contains harmful byproducts of the combusted fuel, such as carbon monoxide or other harmful emissions. These byproducts, as well as the large amount of smoke generated by the combusted fuel, generally prohibit the use of smokers inside the home. Although fume hoods or exhaust systems may be used to route the smoke from indoors to outdoors, such systems would be complex, costly, and frequently not practical or effective.

Due to some manufacturing tolerances, certain gaps may be formed between connection points of one or more aspects of the smoker. These gaps may be increased over time due to routine heating and cooling, general operation, or the like. Accordingly, a smoker that obviates one or more of the above-mentioned drawbacks would be beneficial. In particular, a smoker optimized for use indoors by reducing smoke seepage would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, an indoor smoker is provided. The indoor smoker may include a cabinet defining a discharge vent; a smoking chamber positioned within the cabinet and defining a plurality of openings, the plurality of openings including a chamber inlet and a chamber outlet; a smoke generation system positioned within the cabinet in fluid communication with the smoking chamber; an exhaust duct provided between the chamber outlet and the discharge vent; an air handler provided within the exhaust duct for urging a flow of smoke from the smoking chamber, through the exhaust duct, and out of the discharge vent, the air handler creating a negative pressure within the smoking chamber; a catalytic converter positioned within the exhaust duct upstream from the air handler, the catalytic converter including a catalytic element and a catalyst heater; and a plurality of seals provided within the cabinet. The plurality of seals may include an inlet seal provided at the chamber inlet between the smoke generation system and the smoking chamber and an outlet seal provided at the chamber outlet between the exhaust duct and the smoking chamber.

In another exemplary aspect of the present disclosure, an indoor smoker is provided. The indoor smoker may include a cabinet defining a discharge vent; a smoking chamber positioned within the cabinet and defining a plurality of openings, the plurality of openings including a chamber inlet and a chamber outlet; a smoke generation system positioned within the cabinet in fluid communication with the smoking chamber, the smoke generation system including a hopper, an auger, and a smoldering heater; an exhaust duct provided between the chamber outlet and the discharge vent; an air handler provided within the exhaust duct for urging a flow of smoke from the smoking chamber, through the exhaust duct, and out of the discharge vent, the air handler creating a negative pressure within the smoking chamber; a catalytic converter positioned within the exhaust duct upstream from the air handler, the catalytic converter including a catalytic element and a catalyst heater; and a plurality of seals provided within the cabinet. The plurality of seals may include an inlet seal provided at the chamber inlet between the smoke generation system and the smoking chamber and an outlet seal provided at the chamber outlet between the exhaust duct and the smoking chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an indoor smoker with a door in a closed position in accordance with an example embodiment of the present disclosure.

FIG. 2 provides a perspective view of the exemplary indoor smoker of FIG. 1 with the door opened.

FIG. 3 provides a partial perspective view of the exemplary indoor smoker of FIG. 1 according to an exemplary embodiment of the present subject matter.

FIG. 4 is a front cross-sectional view of the exemplary indoor smoker of FIG. 1 according to an exemplary embodiment of the present subject matter.

FIG. 5 is a side cross sectional view of the exemplary indoor smoker of FIG. 1 according to an exemplary embodiment of the present subject matter.

FIG. 6 provides another partial perspective view of the exemplary indoor smoker of FIG. 1 according to an exemplary embodiment of the present subject matter.

FIG. 7 provides another partial perspective view of the exemplary indoor smoker of FIG. 1 according to an exemplary embodiment of the present subject matter.

FIG. 8 illustrates a schematic diagram of the exemplary indoor smoker of FIG. 1.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

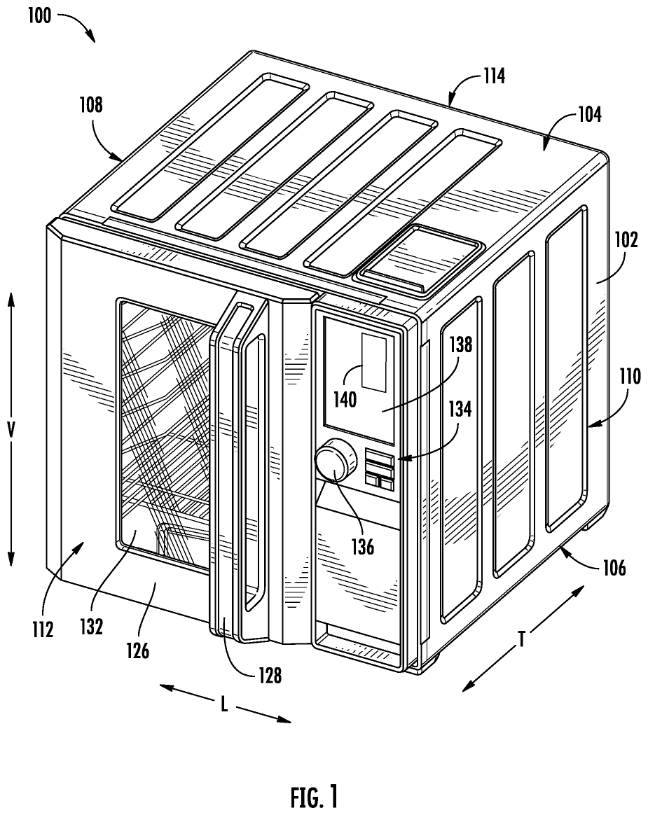

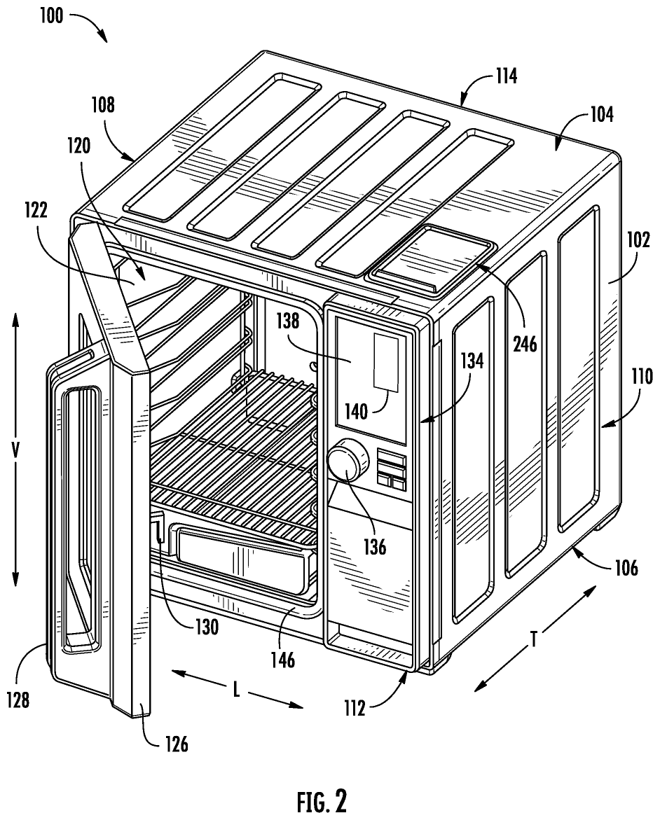

FIGS. 1 and 2 provide perspective views of an indoor smoker 100 according to an exemplary embodiment of the present subject matter with the door in the closed position and the open position, respectively. Indoor smoker 100 generally defines a vertical direction V, a lateral direction L, and a transverse direction T, each of which is mutually perpendicular, such that an orthogonal coordinate system is generally defined. As illustrated, indoor smoker 100 includes an insulated cabinet 102. Cabinet 102 of indoor smoker 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

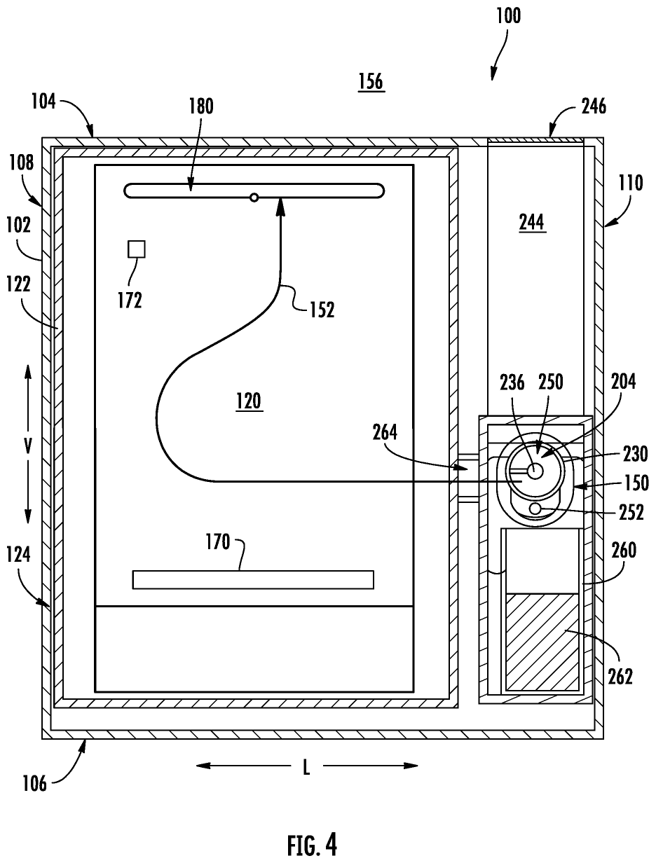

Within cabinet 102 is a smoking chamber 120 which is configured for the receipt of one or more food items to be cooked and/or smoked. In general, smoking chamber 120 is at least partially defined by a plurality of chamber walls 122. Specifically, smoking chamber 120 may be defined by a top wall, a rear wall, a bottom wall, and two sidewalls. These chamber walls 122 may define smoking chamber 120 and an opening through which a user may access food articles placed therein. In addition, chamber walls 122 may be joined, sealed, and insulated to help retain smoke and heat within smoking chamber 120. In this regard, for example, in order to insulate smoking chamber 120, indoor smoker 100 includes an insulation gap 124 (FIG. 4) defined between chamber walls 122 and cabinet 102. According to an exemplary embodiment, insulation gap 124 is filled with insulating material (not shown), such as insulating foam or fiberglass.

Indoor smoker 100 includes a door 126 rotatably attached to cabinet 102 in order to permit selective access to smoking chamber 120. A handle 128 is mounted to door 126 to assist a user with opening and closing door 126. A latch 130 (FIG. 2) may be mounted to cabinet 102. Latch 130 may selectively hold or maintain door 126 in the closed position during a cooking or smoking operation. In addition, door 126 may include one or more transparent viewing windows 132 to provide for viewing the contents of smoking chamber 120 when door 126 is closed and also to assist with insulating smoking chamber 120. Additionally or alternatively, indoor smoker 100 may include a door seal 146. Door seal may be provided at or around a periphery of door 126 (e.g., to seal door 126 to cabinet 102). Door seal 146 may be a gasket attached to one of door 126 or cabinet 102. Accordingly, door seal 146 may restrict smoke formed and flowing within indoor smoker 100 from escaping smoking chamber 120.

Referring still to FIGS. 1 and 2, a user interface panel 134 and a user input device 136 may be positioned on an exterior of cabinet 102. User interface panel 134 may represent a general purpose Input/Output (“GPIO”) device or functional block. In some embodiments, user interface panel 134 may include or be in operative communication with user input device 136, such as one or more of a variety of digital, analog, electrical, mechanical or electro-mechanical input devices including rotary dials, control knobs, push buttons, and touch pads. User input device 136 is generally positioned proximate to user interface panel 134, and in some embodiments, user input device 136 may be positioned on user interface panel 134. User interface panel 134 may include a display component 138, such as a digital or analog display device designed to provide operational feedback to a user.

Generally, indoor smoker 100 may include a controller 140 in operative communication with user input device 136. User interface panel 134 of indoor smoker 100 may be in communication with controller 140 via, for example, one or more signal lines or shared communication busses, and signals generated in controller 140 operate indoor smoker 100 in response to user input via user input devices 136. Input/Output (“I/O”) signals may be routed between controller 140 and various operational components of indoor smoker 100 such that operation of indoor smoker 100 can be regulated by controller 140.

Controller 140 is a “processing device” or “controller” and may be embodied as described herein. Controller 140 may include a memory and one or more microprocessors, microcontrollers, application-specific integrated circuits (ASICS), CPUs or the like, such as general or special purpose microprocessors operable to execute programming instructions or micro-control code associated with operation of indoor smoker 100, and controller 140 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 140 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Although aspects of the present subject matter are described herein in the context of an indoor smoker having a single smoking chamber, it should be appreciated that indoor smoker 100 is provided by way of example only. Other smoking appliances having different configurations, different appearances, and/or different features may also be utilized with the present subject matter, e.g., outdoor smokers, conventional oven appliances, or other suitable cooking appliances. Thus, the example embodiment shown in FIG. 1 is not intended to limit the present subject matter to any particular smoking configuration or arrangement. Moreover, aspects of the present subject matter may be used in any other consumer or commercial appliance where it is desirable to regulate a flow of smoke or harmful emissions in an appliance.

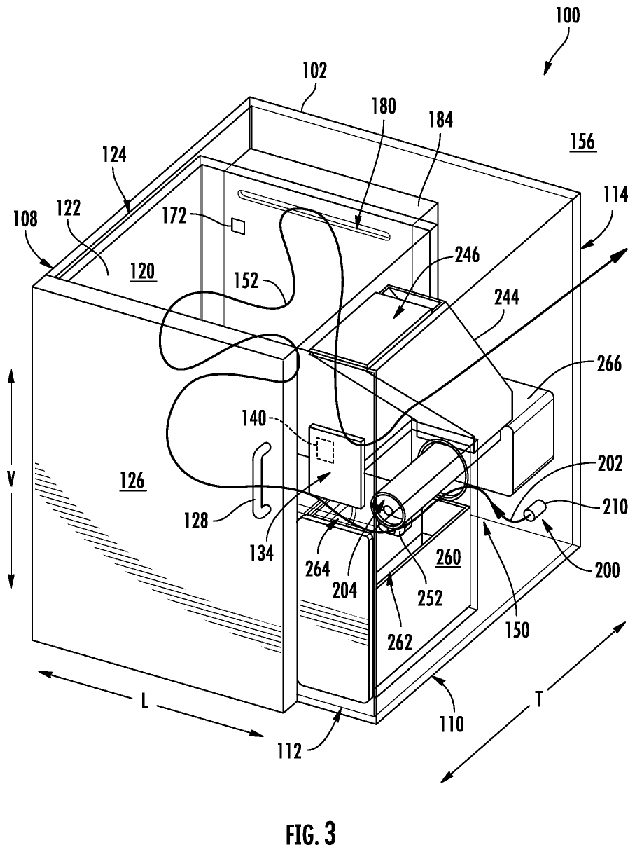

Referring now also to FIG. 3, various internal components of an indoor smoker 100 and their respective functions will be described according to an exemplary embodiment of the present subject matter. In this regard, FIG. 3 illustrates a partial perspective view of an indoor smoker 100 similar to that shown in FIG. 1. As shown, indoor smoker 100 generally includes smoking chamber 120 for receiving items to be cooked/smoked, a smoke generating device or smoke generating assembly 150 for generating a flow of smoke (indicated by reference numeral 152 in FIG. 3), and an exhaust system 154 for safely discharging the air and/or smoke into an indoor environment 156 (i.e., outside of indoor smoker 100). Each of these systems and components will be described in detail below.

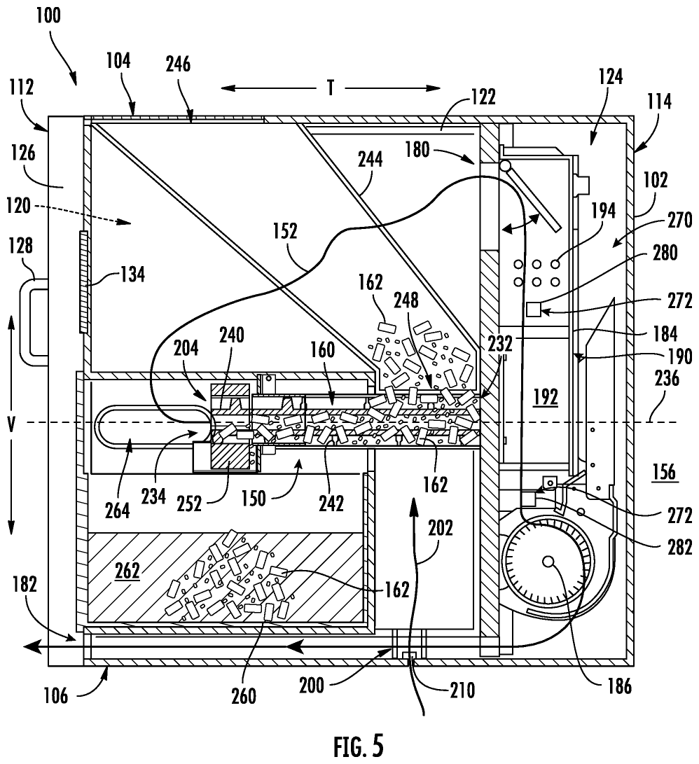

Referring to FIG. 5, smoke generating assembly 150 generally defines a smoldering chamber 160 which is configured for receiving combustible material 162. As used herein, “combustible material” is generally used to refer to any suitable material positioned within smoldering chamber 160 for generating smoke. Specifically, according to exemplary embodiments, combustible material 162 includes wood or wood byproducts, such as wood chunks, wood chips, wood pellets, or wood resin. According to the exemplary embodiment, smoke generating assembly 150 may include a door or another access panel for providing selective access to smoldering chamber 160, e.g., to add additional combustible material 162.

As best shown in FIG. 4, in order to ensure a desirable cooking temperature within smoking chamber 120, indoor smoker 100 further includes a chamber heater 170 that is positioned within or otherwise in thermal communication with smoking chamber 120 for regulating the temperature in smoking chamber 120. In general, chamber heater 170 may include one or more heating elements positioned within cabinet 102 for selectively heating smoking chamber 120. For example, the heating elements may be electric resistance heating elements, gas burners, microwave heating elements, halogen heating elements, or suitable combinations thereof. Notably, because chamber heater 170 is operated independently of smoke generating assembly 150 (e.g., as described below), smoking chamber 120 may be maintained at any suitable temperature during a smoking process. More specifically, for example, chamber heater 170 may be turned off or on a very low setting for smoking cheeses or may be turned on high for quickly cooking and smoking meats.

In some embodiments, indoor smoker 100 also includes one or more sensors that may be used to facilitate improved operation of the appliance, such as described below. For example, indoor smoker 100 may include one or more temperature sensors which are generally operable to measure the internal temperature in indoor smoker 100, e.g., within smoking chamber 120 and/or smoldering chamber 160. More specifically, as illustrated, indoor smoker 100 includes a temperature sensor 172 positioned within smoking chamber 120 and being operably coupled to controller 140. In some embodiments, controller 140 is configured to vary operation of chamber heater 170 based on one or more temperatures detected by temperature sensor 172.

As described herein, “temperature sensor” may refer to any suitable type of temperature sensor. For example, the temperature sensors may be thermocouples, thermistors, or resistance temperature detectors. In addition, temperature sensor 172 may be mounted at any suitable location and in any suitable manner for obtaining a desired temperature measurement, either directly or indirectly. Although exemplary positioning of certain sensors is described below, it should be appreciated that indoor smoker 100 may include any other suitable number, type, and position of temperature sensors according to alternative embodiments.

As mentioned briefly above, indoor smoker 100 further includes an exhaust system 154 which is generally configured for safely discharging the flow of smoke 152 from indoor smoker 100. Specifically, according to the illustrated embodiment, exhaust system 154 generally extends between a chamber outlet 180 and a discharge vent 182 defined by cabinet 102 for directing the flow of smoke 152 from smoking chamber 120 to the environment 156. Although an exemplary exhaust system 154 is described below, it should be appreciated that variations and modifications may be made while remaining within the scope of the present subject matter. For example, the routing of ducts, the catalytic converter arrangement, and the types of sensors used may vary according to alternative embodiments. For example, although discharge vent 182 is illustrated as being defined proximate a front and bottom of cabinet 102, other suitable positions of discharge vent 182 and routing of the exhaust are possible and within the scope of the present subject matter.

As shown, exhaust system 154 includes an exhaust duct 184 that generally extends between and provides fluid communication between chamber outlet 180 and discharge vent 182. Exhaust duct 184 may be coupled to smoking chamber 120 (e.g., via an outer surface of one of chamber walls 122). For instance, exhaust duct 184 may be fixed to chamber wall 122 via a plurality of fasteners 158. As such, at least a portion of exhaust duct 184 may be provided flush against chamber wall 122 and coupled via the plurality of fasteners 158. Additionally or alternatively, at least a portion of exhaust duct 184 may interlock with at least a portion of chamber wall 122 (e.g., via one or more mechanical fingers, overlaps, or the like). Advantageously, exhaust duct 184 may be prevented from warping (e.g., away from the outer surface of chamber wall 122) due to excessive heat produced within the catalytic converter arrangement (described in further detail below).

Indoor smoker 100 further includes an air handler 186 that is operably coupled with exhaust duct 184 facilitating the smoldering process and smoke generating process. For example, air handler 186 urges the flow of smoke 152 through exhaust duct 184 and out of discharge vent 182 to environment 156. According to the illustrated exemplary embodiment, air handler 186 is a centrifugal fan positioned within exhaust duct 184. However, it should be appreciated that according to alternative embodiments, air handler 186 may be positioned at any other suitable location and may be any other suitable fan type, such as a tangential fan, an axial fan, etc.

In addition, according to an exemplary embodiment, air handler 186 is a variable speed fan such that it may rotate at different rotational speeds, thereby generating different air flow rates. In this manner, the amount of smoke drawn from smoldering chamber 160 may be continuously and precisely regulated. Moreover, by pulsing the operation of air handler 186 or throttling air handler 186 between different rotational speeds, the flow of smoke 152 drawn into smoking chamber 120 may enter from a different direction, may have a different flow velocity, or may generate a different flow pattern within smoking chamber 120. Thus, by pulsating the variable speed fan or otherwise varying its speed, the flow of smoke 152 may be randomized, thereby eliminating stagnant regions within smoking chamber 120 and better circulating the flow of smoke 152 to provide a more even cooking/smoking profile.

Air handler 186 may thus create a negative pressure within smoking chamber 120. In detail, Air handler 186 is operated so as to draw fluid (e.g., air and smoke) from smoke generating assembly 150, through smoking chamber 120, and into exhaust duct 184 (e.g., into catalytic converter 190). Air handler 186 may thus be tuned to create and maintain a predetermined negative pressure range within smoking chamber 120 (or within indoor smoker 100). The negative pressure formed within smoking chamber 120 may be directly proportional to a size of smoking chamber 120. For instance, the negative pressure formed within smoking chamber 120 may be directly proportional to a volume within smoking chamber 120. Accordingly, as a volume of smoking chamber 120 is increased, the negative pressure created by air handler 186 also increases. Advantageously, a proper negative pressure formed within smoking chamber 120 by air handler 186 may reduce a seeping of aromas from the smoke or food items within smoking chamber 120. In other words, the proper negative pressure may ensure that the smoke is urged into catalytic converter 190 and does not escape indoor smoker 100, thus improving user experience.

According to at least some embodiments, as mentioned above, air handler 186 may be a variable speed or a variable power fan. For instance, air handler 186 may include a fan motor to provide rotational power to a fan (e.g., including one or more fan blades) to induce the airflow through indoor smoker 100. A size (e.g., physical size, power output, etc.) of the fan motor may vary according to specific embodiments (e.g., according to a volumetric size of smoking chamber 120). Accordingly, as the volumetric size of smoking chamber 120 increases, the size (e.g., output) of the fan motor increases. For at least one example, the negative pressure to be maintained within smoking chamber is between about −5 (negative five) Pascals (Pa) and about −25 Pa, such as between about −10 Pa and about −20 Pa. It should be noted that the figures given herein are exemplary, and the negative pressure within smoking chamber 120 may vary according to specific embodiments. As will be described below, the negative pressure created within smoking chamber 120 may be assisted or modified by one or more seals (e.g., provided at gaps or apertures formed in chamber walls 122).

As illustrated, indoor smoker 100 further includes a catalytic converter 190 which is positioned within exhaust duct 184 for lowering or removing combustion gases and volatile organic compounds (VOCs) from the flow of smoke 152. As used herein, “catalytic converter” or variations thereof may be used to refer to any component, machine, or device that is configured for removing or lowering volatile organic compounds (VOCs), toxic gases, harmful emissions, pollutants, or undesirable compounds from a flow of air and smoke. For example, according to the illustrated embodiment, catalytic converter 190 generally includes a catalytic element 192 and a catalyst heater 194. Although catalytic converter 190 is illustrated herein as being positioned within exhaust duct 184, it should be appreciated that according to other embodiments catalytic converter 190 be positioned at any other suitable location, so long as catalytic converter 190 is inline with the flow of smoke 152, such that volatile organic compounds and gases may be reduced.

In general, catalytic element 192 includes a material that causes an oxidation and a reduction reaction. For example, precious metals such as platinum, palladium, and rhodium are commonly used as catalyst materials, though other catalysts are possible and within the scope of the present subject matter. In operation, the catalytic element 192 may combine oxygen (O₂) with carbon monoxide (CO) and unburned hydrocarbons to produce carbon dioxide (CO₂) and water (H₂O). In addition, according to exemplary embodiments, catalytic element 192 may remove nitric oxide (NO) and nitrogen dioxide (NO₂).

Notably, catalytic converters typically require that the catalyst be heated to a suitably high temperature in order to catalyze the necessary chemical reactions. Therefore, catalyst heater 194 is in thermal communication with catalytic element 192 for heating it to a suitable temperature, such as approximately 800° F. According to the illustrated embodiment, catalyst heater 194 is positioned upstream of catalytic element 192 to provide thermal energy through convection. However, it should be appreciated that according to alternative embodiments, catalyst heater 194 may be in direct contact with catalytic element 192 to provide thermal energy through conduction, or may be thermally coupled to catalytic element 192 in any other suitable manner. In order to ensure a catalyst temperature of catalytic element 192 remains above a temperature suitable for controlling emissions, indoor smoker 100 may further include a catalyst temperature sensor (not shown) that may be monitored by controller 140.

Referring still to FIG. 5, the construction and operation of smoke generating assembly 150 will be described in more detail according to an exemplary embodiment of the present subject matter. As illustrated, indoor smoker 100 defines an air inlet 200 for receiving air to support the combustion or smoldering process. Specifically, air inlet 200 is configured for receiving a flow of combustion air (indicated by reference numeral 202 in FIG. 5) from the ambient environment 156 surrounding indoor smoker 100 or from another air supply source. During a smoking process, combustible material 162 is ignited and the flow of combustion air 202 supports the smoldering process to generate the flow of smoke 152. Smoke generating assembly 150 further defines a smoke outlet 204 for providing a flow of smoke 152 into smoking chamber 120 during a smoking operation, as will be described in detail below.

In addition, indoor smoker 100 may further include features for preventing or regulating the flow of combustion air 202 from entering indoor smoker 100 from environment 156 when the flow of such air is not desired. In this regard, for example, indoor smoker 100 may include an inlet check valve 210 which is operably coupled to air inlet 200. In general, this check valve prevents the flow of combustion air 202 from entering smoldering chamber 160 when not desired. For example, inlet check valve 210 may have a “cracking pressure,” which is used herein to refer to the pressure, or more precisely the negative pressure, required within smoldering chamber 160 to open inlet check valve 210. In this manner, inlet check valve 210 may be designed to permit the flow of combustion air 202 only when air handler 186 is operating and urging air through smoldering chamber 160, thus facilitating the quick and effective asphyxiation of combustible material 162 within smoldering chamber 160 when desired.

According to the illustrated embodiment, smoke generating assembly 150 generally includes a smoke barrel 230 that defines smoldering chamber 160. Specifically, smoke barrel 230 extends between a first end 232 and a second end 234 substantially along a central axis 236. Specifically, as illustrated, central axis 236 extends substantially within a horizontal plane within cabinet 102, e.g., directly along the transverse direction T. In general, smoke barrel 230 is configured for receiving the combustible material 162 and facilitating a smoldering process. As shown, smoke barrel 230 has a substantially cylindrical shape and is formed from a substantially rigid and temperature resistant material, such as steel. However, it should be appreciated that smoke barrel 230 may be formed from different materials, may have different geometries, and may be configured differently within cabinet 102 according to alternative embodiments of the present subject matter.

Smoke generating assembly 150 further includes a rotating auger 240 that is rotatably mounted within smoldering chamber 160 and generally rotates about central axis 236, e.g., such that rotating auger 240 is coaxial with smoke barrel 230. As shown, an outer diameter of rotating auger 240 is substantially equivalent to an inner diameter of smoke barrel 230, such that a helical blade 242 of rotating auger 240 may advance combustible material 162 within smoldering chamber 160 as rotating auger 240 is rotated about central axis 236. More specifically, the combustible material 162 is generally urged from first end 232 toward second end 234 of smoke barrel 230.

As illustrated, smoke generating assembly 150 may further include a hopper 244 that is generally configured for storing and selectively depositing combustible material 162 into smoldering chamber 160. More specifically, as illustrated, hopper 244 may be a large, tapered reservoir with a top opening 246 positioned at top 104 of cabinet 102. A user may fill hopper 244 by pouring or providing combustible material 162 into hopper 244 through top opening 246. Hopper 244 may taper toward a supply opening 248 positioned at a bottom of hopper 244. As shown, supply opening 248 opens into smoldering chamber 160 at a top of smoke barrel 230. More specifically, supply opening 248 is joined to smoke barrel 230 proximate first end 232 of smoke barrel 230. In this manner, fresh combustible material 162 is typically provided into smoldering chamber 160 proximate first end 232 of smoke barrel 230 and is urged by rotating auger 240 toward second end 234 of smoke barrel 230. As illustrated, smoke generating assembly 150 may generally define a discharge port 250 proximate second end 234 of smoke barrel 230 for discharging consumed combustible material 162.

Smoke generating assembly 150 further includes one or more smoldering heaters 252 which are positioned adjacent smoldering chamber 160 or otherwise placed in thermal communication with combustible material 162 stored in smoldering chamber 160 for smoldering combustible material 162. According to an exemplary embodiment, smoldering heater 252 may include one or more cartridge heaters or silicon nitride igniters. Alternatively, smoldering heater 252 may include any other suitable type, position, and configuration of heating elements. As used herein, the term “heating element,” “heaters,” and the like may generally refer to electric resistance heating elements, gas burners, microwave heating elements, halogen heating elements, or suitable combinations thereof.

As used herein, the verb “smolder” or variations thereof is intended to refer to burning a combustible material (e.g., combustible material 162) slowly such that smoke is generated but little or no flame is generated. In this manner, the combustible material is not expended quickly, but a large amount of smoke is generated for the smoking process. Notably, the burn rate of combustible material and the amount of smoke generated is regulated using smoldering heater 252 positioned within smoldering chamber 160. For typical combustible material used in smokers, e.g., wood and wood byproducts, a typical smoldering temperature is between about 650° F. and 750° F. However, the exact temperature may vary depending on the combustible material used, the air flow rate through smoldering chamber 160, the level of combustible material 162, and other factors.

According to the exemplary illustrated embodiment, smoldering heater 252 is positioned proximate second end 234 of smoke barrel 230. For example, smoldering heater 252 may at least partially define smoke outlet 204 of smoke generating assembly 150. Specifically, as illustrated, smoke outlet 204 corresponds to discharge port 250 of smoke generating assembly 150, which may simply be an open end of smoldering heater 252. In this manner, as rotating auger 240 rotates, combustible material 162 positioned within smoldering chamber 160 is slowly but progressively advanced past smoldering heater 252. After combustible material 162 positioned near smoldering heater 252 is consumed or smoldered, rotating auger 240 may rotate to advance the consumed material toward discharge port 250 where it may be pushed out of smoldering chamber 160.

According to exemplary embodiments, smoldering heater 252 may be positioned on a distal end of rotating auger 240, e.g., aligned along central axis 236 proximate second end 234. As such, rotating auger 240 may pass through smoke barrel 230 and through a central aperture smoldering heater 252 to extend out of discharge port 250. In this manner, rotating auger 240 may serve to advance combustible material 162 from first end 232 of smoke barrel 230, past second end 234 of smoke barrel 230, through and across smoldering heater 252, then out of discharge port 250.

According to an exemplary embodiment, a waste container 260 may be configured for receiving consumed combustible material 162 when discharged from smoke generating assembly 150. In this regard, for example, waste container 260 may be positioned directly below smoke barrel 230, smoldering heater 252, and/or discharge port 250 such that used combustible material 162 may fall therein and immediately extinguish. For example, according to the illustrated embodiment, waste container 260 is filled with water 262 to immediately extinguish combustible material 162 when dropped into container 260. However, it should be appreciated that other liquids or materials for extinguishing combustible material 162 may be contained within waste container 260. In addition, as illustrated, waste container 260 may be positioned below or directly define a chamber inlet 264 that is positioned adjacent smoke outlet 204. In this manner, the flow of smoke 152 exiting smoke barrel 230 may pass directly into smoking chamber 120 through chamber inlet 264 while consumed combustible material 162 may fall directly into water 262 within container 260.

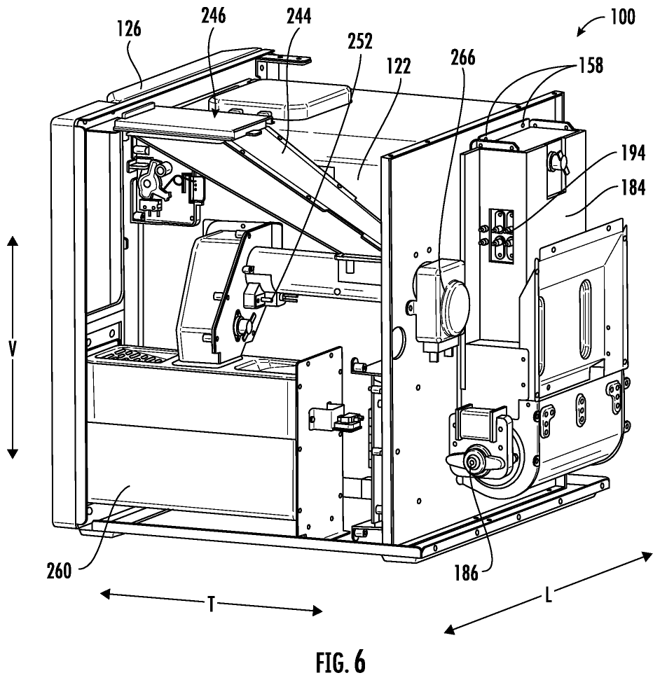

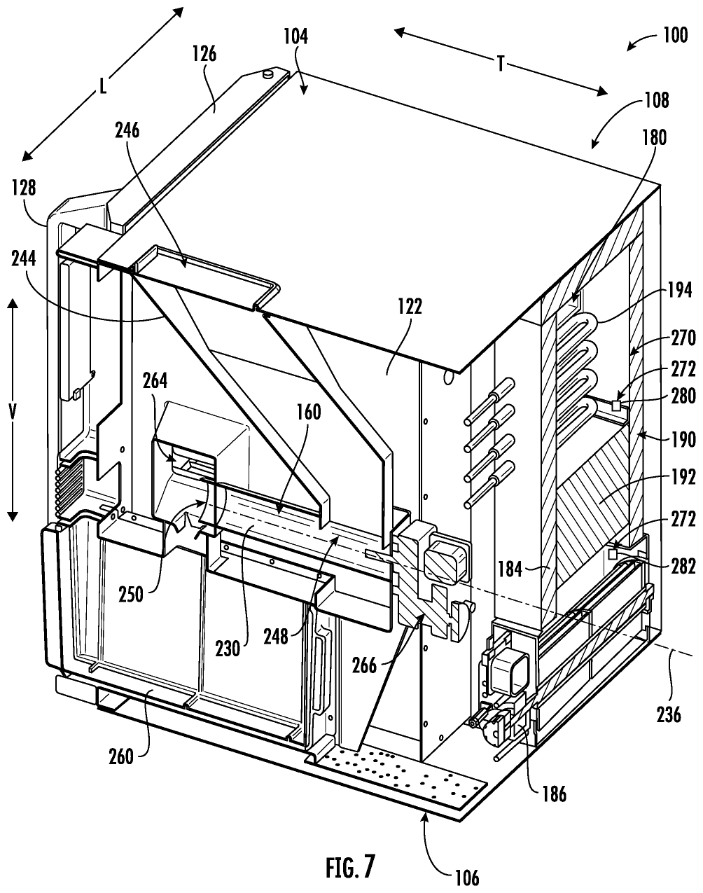

As best illustrated in FIGS. 6 and 7, smoke generating assembly 150 may further include a drive mechanism 266 that is mechanically coupled to rotating auger 240. Controller 140 (or another dedicated controller) may be in operative communication with drive mechanism 266 and may be configured for intermittently rotating the rotating auger 240 to advance combustible material 162 along central axis 236. Specifically, drive mechanism 266 may include a drive motor and a transmission assembly or another suitable geared arrangement for transferring torque from the drive motor to rotating auger 240. As used herein, “motor” may refer to any suitable drive motor and/or transmission assembly for driving rotating auger 240. For example, the drive motor may be a brushless DC electric motor, a stepper motor, or any other suitable type or configuration of motor. For example, the drive motor may be an AC motor, an induction motor, a permanent magnet synchronous motor, or any other suitable type of AC motor. In addition, the drive motor and the transmission assembly may include any suitable motor or transmission sub-assemblies, clutch mechanisms, or other components.

In order to facilitate proper smoldering of combustible material 162, it may be desirable to drive rotating auger 240 intermittently, e.g., in a non-continuous manner. Specifically, according to an exemplary embodiment, rotating auger 240 may be rotated for a particular time duration once during every predetermined rotation period. For example, the time duration of rotation may be the amount of time drive mechanism 266 should drive rotating auger 240 to discharge all combustible material 162 that is smoldering from smoke barrel 230. In addition, the predetermined rotation period may be the amount of time necessary for a fresh portion of the smoldering material 162 to be consumed. Notably, drive mechanism 266 may discharge combustible material 162 from smoke barrel 230 before combustible material 162 is fully consumed, e.g., to prevent forming ash which may introduce acrid smoke flavors. According to an exemplary embodiment, the time duration of rotation is approximately 12 seconds while the predetermined rotation period is five minutes. Other rotation schedules are possible and within the scope of the present subject matter. Indeed, such rotation schedules may vary based on a variety of factors, such as the combustible material used, the temperature of the smoldering heater, the rate of air flow through smoke barrel 230, etc.

Thus, during operation of indoor smoker 100, air handler 186 draws the flow of combustion air 202 into smoldering chamber 160 through air inlet 200. The flow of combustion air 202 and combustible material 162 in the smoldering chamber 160 generate the flow of smoke 152 which is drawn into smoking chamber 120 as described herein. The flow of smoke 152 passes through smoking chamber 120 for performing a smoking process on food items positioned therein before exiting smoking chamber 120 through chamber outlet 180. Air handler 186 then continues to urge the flow of smoke 152 through catalytic converter 190 and exhaust duct 184 before passing out discharge vent 182.

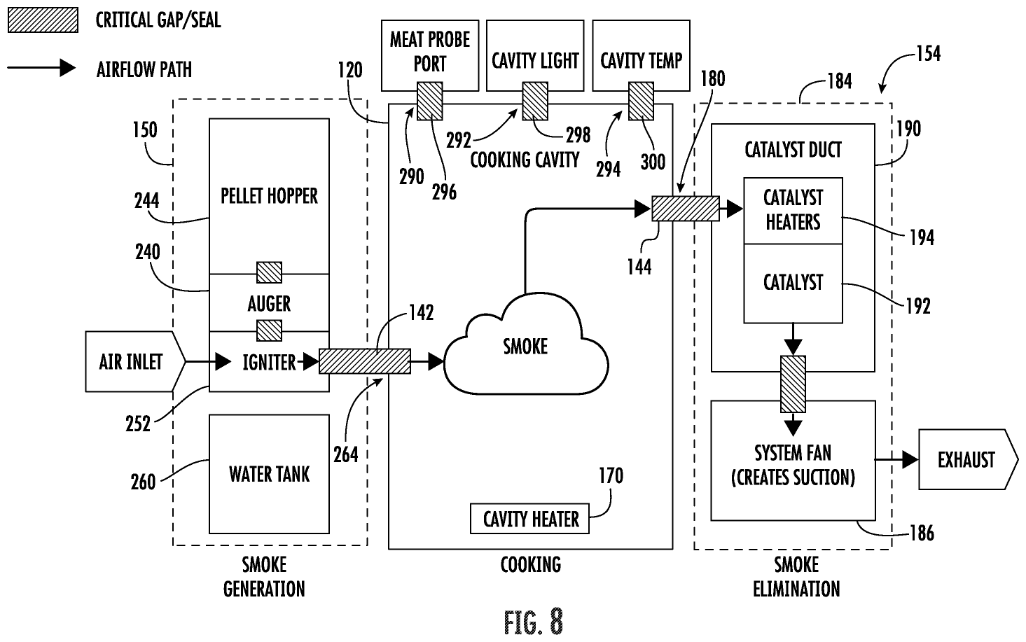

Referring now to FIG. 8, a schematic diagram of indoor smoker 100 including smoke generating assembly (or smoke generation system) 150 and exhaust duct 184 is provided. As described above, the flow of smoke 152 may pass from smoke generation system 150 into smoking chamber 120 via chamber inlet 264. In order to ensure a maximum amount of the smoke enters smoking chamber 120 and does not seep (e.g., via a gap between smoke generation system 150 and smoking chamber 120), a chamber inlet seal 142 may be provided at chamber inlet 264. For instance, chamber inlet seal 142 may seal (e.g., within a predetermined percentage of air-tight) chamber inlet 264 to prevent the flow of smoke 152 from entering gaps within insulated cabinet 102. As mentioned above, air handler 186 may be operated at a predetermined power level (or speed) to create the predetermined negative pressure within smoking chamber 120. At the predetermined negative pressure, chamber inlet seal 142 restricts the flow of smoke 152 from escaping the confines of indoor smoker 100 before reaching catalytic converter 190.

Further, a chamber outlet seal 144 may be provided at chamber outlet 180. Similar to chamber inlet seal 142, chamber outlet seal 144 may seal (e.g., within a predetermined percentage of air-tight) chamber outlet 180 to prevent the flow of smoke 152 from entering gaps within insulated cabinet 102. As mentioned above, air handler 186 may be operated at a predetermined power level (or speed) to create the predetermined negative pressure within smoking chamber 120. At the predetermined negative pressure, chamber outlet seal 144 restricts the flow of smoke 152 from escaping the confines of indoor smoker 100 before reaching catalytic converter 190. Thus, each of chamber inlet 264 and chamber outlet 180 may be referred to as controlled gaps within indoor smoker 100. Each controlled gap may include a seal (e.g., chamber inlet seal 142, chamber outlet seal 144).

The seals (e.g., chamber inlet seal 142, chamber outlet seal 144) may be formed from a predetermined sealing material. For instance, the seals may be formed forma silicon-based material. In some instances, the seals include a silicon caulk. Additionally or alternatively, fiberglass-based materials may be included in the seals. It should be noted that the seals described herein are provided by way of example only, and that any suitable material may be used for chamber inlet seal 142, chamber outlet seal 144, and the like.

In additional or alternative embodiments, smoking chamber 120 includes apertures formed therein in addition to chamber inlet 264 and chamber outlet 180. For instance, with reference to FIG. 8, indoor smoker 100 may optionally include one or more of a probe port (e.g., meat probe port) 290, a cavity light port 292, and a temperature sensor port 294. As shown, each of the probe port 290, cavity light port 292, and temperature sensor port 294 may be formed through a top wall (e.g., of chamber walls 122). Accordingly, indoor smoker 100 may thus include a probe port seal 296, a cavity light seal 298, and a temperature sensor port seal 300.

Probe port seal 296 may be provided at probe port 290, cavity light seal 298 may be provided at cavity light port 292, and temperature sensor port seal 300 may be provided at temperature sensor port 294. Similar to each of chamber inlet seal 142 and chamber outlet seal 144 described above, at the predetermined negative pressure created by air handler 186, probe port seal 296, cavity light seal 298, and temperature sensor port seal 300 may restrict the flow of smoke 152 from escaping the confines of indoor smoker 100 before reaching catalytic converter 190 (e.g., into spaces defined for a meat probe, a cavity light, a temperature sensor, and the like). Additionally or alternatively, each of probe port seal 296, cavity light seal 298, and temperature sensor port seal 300 may be formed of a silicon-based material. Moreover, it should be understood that the seals mentioned and described herein are provided by way of example only, and more or fewer seals may be included according to specific embodiments.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An indoor smoker comprising:
a cabinet defining a discharge vent;
a smoking chamber positioned within the cabinet and defining a plurality of openings, the plurality of openings comprising a chamber inlet and a chamber outlet;
a smoke generation system positioned within the cabinet in fluid communication with the smoking chamber;
an exhaust duct provided between the chamber outlet and the discharge vent;
an air handler provided within the exhaust duct for urging a flow of smoke from the smoking chamber, through the exhaust duct, and out of the discharge vent, the air handler creating a negative pressure within the smoking chamber;
a catalytic converter positioned within the exhaust duct upstream from the air handler, the catalytic converter comprising a catalytic element and a catalyst heater; and
a plurality of seals provided within the cabinet, the plurality of seals comprising:
an inlet seal provided at the chamber inlet between the smoke generation system and the smoking chamber; and
an outlet seal provided at the chamber outlet between the exhaust duct and the smoking chamber.

2. The indoor smoker of claim 1, wherein an airflow capacity of the air handler is directly proportional to a volumetric size of the smoking chamber.

3. The indoor smoker of claim 2, wherein a negative pressure value created by the air handler within the smoking chamber is directly proportional to the airflow capacity of the air handler.

4. The indoor smoker of claim 1, wherein the negative pressure within the smoking chamber created by the air handler is between minus 10 and minus 20 Pascals (Pa).

5. The indoor smoker of claim 1, wherein the plurality of openings further comprises:
a probe port;
a cavity light port; and
a temperature sensor port.

6. The indoor smoker of claim 3, wherein the plurality of seals further comprises:
a probe port seal provided at the probe port;
a cavity light seal provided at the cavity light port; and
a temperature sensor port seal provided at the temperature sensor port.

7. The indoor smoker of claim 1, wherein each of the plurality of seals is formed from a silicon based material.

8. The indoor smoker of claim 1, further comprising:
a door rotatably attached to the cabinet to provide selective access to the smoking chamber; and
a door seal provided around a periphery of the door.

9. The indoor smoker of claim 1, wherein the exhaust duct is fixed to the smoking chamber via a plurality of fasteners.

10. An indoor smoker comprising:
a cabinet defining a discharge vent;
a smoking chamber positioned within the cabinet and defining a plurality of openings, the plurality of openings comprising a chamber inlet and a chamber outlet;
a smoke generation system positioned within the cabinet in fluid communication with the smoking chamber, the smoke generation system comprising a hopper, an auger, and a smoldering heater;
an exhaust duct provided between the chamber outlet and the discharge vent;
an air handler provided within the exhaust duct for urging a flow of smoke from the smoking chamber, through the exhaust duct, and out of the discharge vent, the air handler creating a negative pressure within the smoking chamber;
a catalytic converter positioned within the exhaust duct upstream from the air handler, the catalytic converter comprising a catalytic element and a catalyst heater; and
a plurality of seals provided within the cabinet, the plurality of seals comprising:
an inlet seal provided at the chamber inlet between the smoke generation system and the smoking chamber; and
an outlet seal provided at the chamber outlet between the exhaust duct and the smoking chamber.

11. The indoor smoker of claim 10, wherein an airflow capacity of the air handler is directly proportional to a volumetric size of the smoking chamber.

12. The indoor smoker of claim 11, wherein a negative pressure value created by the air handler within the smoking chamber is directly proportional to the airflow capacity of the air handler.

13. The indoor smoker of claim 10, wherein the negative pressure within the smoking chamber created by the air handler is between minus 10 and minus 20 Pascals (Pa).

14. The indoor smoker of claim 10, wherein the plurality of openings further comprises:
a probe port;
a cavity light port; and
a temperature sensor port.

15. The indoor smoker of claim 14, wherein the plurality of seals further comprises:
a probe port seal provided at the probe port;
a cavity light seal provided at the cavity light port; and
a temperature sensor port seal provided at the temperature sensor port.

16. The indoor smoker of claim 10, wherein each of the plurality of seals is formed from a silicon based material.

17. The indoor smoker of claim 10, further comprising:
a door rotatably attached to the cabinet to provide selective access to the smoking chamber; and
a door seal provided around a periphery of the door.

18. The indoor smoker of claim 10, wherein the exhaust duct is fixed to the smoking chamber via a plurality of fasteners.
